(19) United States
(12) Patent Application Publication
(10) Pub. No.: US 2005/0229951 A1
(43) Pub. Date: Oct. 20, 2005

(54) Method for cleaning tub of washing machine

(76) Inventor: Seok Kyu Park, Gyeongsangnam-do (KR)

Correspondence Address: MCKENNA LONG & ALDRIDGE LLP, 1900 K STREET, NW, WASHINGTON, DC, 20006, US

(21) Appl. No.: 10/516,604

(22) PCT Filed: Mar. 12, 2004
(86) PCT No.: PCT/KR04/00528

§ 371 Date: Dec. 3, 2004

(30) Foreign Application Priority Data
Mar. 14, 2003 (KR) 1020030016119

(51) Int. Cl. B08B 9/00

(52) U.S. Cl. 134/22.1; 134/26; 134/33

(57) ABSTRACT

Method for cleaning a tub of a washing machine including the steps of supplying water to a tub without introduction of laundry into the tub, washing for the first time for permeation of water into contaminants, and removal of contaminants lightly stuck to a surface of the tub, soaking the contaminants for a predetermined time period, washing for the second time for separating soaked contaminants from the surface of the tub, and draining water from the tub, whereby cleaning contaminated tub of the washing machine.

### TECHNICAL FIELD

The present invention is related to washing machines, and more particularly, to a method for cleaning a contaminated tub of a washing machine.

### BACKGROUND ART

The washing machine progresses washing, rinsing, and spinning cycles for removing contaminants from laundry by using action of detergent and water. There are pulsator type washing machines which have a vertical inner tub, and drum type washing machines which have a horizontal rotatable drum.

FIG. 1 illustrates a pulsator type washing machine, referring to which the pulsator type washing machine will be described in more detail.

Referring to FIG. 1, the pulsator type washing machine is provided with a cabinet 10 forming an outside shape of the washing machine, an outer tub 20 in the cabinet 10, an inner tub 30 rotatably mounted on an inside of the outer tub 20, a pulsator 40 rotatably mounted on an inside of the inner tub 30, and a power transmission means for transmitting power from a motor to the inner tub 30 or the pulsator 40.

The outer tub 20, elastically supported on an inside of the cabinet, holds washing water. The inner tub 30 is mounted on the inside of the outer tub 20 with a space from the outer tub 20. While the outer tub 20 does not rotate, the inner tub is rotatable with respect to the outer tub 20. The inner tub 30 has a plurality of pass through holes 31 in a circumference, to make an inside space of the inner tub 30, and an inside space of the outer tub 20 in communication. The pulsator 40 is rotatably mounted on a central part of an inside bottom of the inner tub 30.

The power transmission means includes a clutch 50, a driving motor 60, and a belt 70. The clutch 50 is fixed to a bottom of the outer tub 20, and connected to the pulsator 40 and the inner tub 30 with a shaft, for rotating the pulsator 40 or the inner tub 20. The driving motor 60 is arranged under an outside surface of the outer tub 20, for providing power to the clutch 50. For this, a belt 70 is connected between the clutch 50 and the driving motor 60.

In the meantime, there are a water supply hose 12 connected to one side of an upper part of the cabinet 10, and a drain hose 14 connected to a lower part of the outer tub 20 for draining the washing water. The drain hose 14 is provided with a drain valve 13. There is a display (not shown) in the upper part of the cabinet 10 of the washing machine, for displaying a washing course selected by a user, a state of washing progress, time, and the like.

In the operation, upon selecting a washing mode in a state the laundry and a certain amount of detergent is introduced into the inner tub 30, the washing, rinsing, and spinning cycles are progressed automatically for a certain time period in response to a control signal from a controller (not shown), which will be described, hereafter.

Upon selection of a washing mode, the water supply valve 11 on the water supply hose 12 is opened, to supply water to the inner tub 30 through the water supply hose 12. The washing water is introduced not only to the inner tub 30, but also to the outer tub 20 through the pass through hole 31.

When the washing water is filled to a certain level in the outer tub 20 and the inner tub 30, the water supply is stopped as the water supply valve 11 is closed. Then, the driving motor 60 rotates in a regular or reverse direction, to drive the clutch 50, and the clutch 50 rotates the inner tub 30 and the pulsator 40 selectively proper to required washing cycles. According to this, the laundry in the inner tub 30 is washed by a rotation power of the pulsator 40, a friction force between the laundry and an inside surface of the inner tub 30, a friction force caused by water circulation, and a decomposing capability of the detergent.

When the washing cycle is finished according to above actions, the drain valve 13 is opened in response to the control signal from the controller (not shown), to drain the washing water to an outside of the cabinet 10 through the drain hose 14.

Upon finishing the drain, new washing water is supplied to the inner tub 30, and the pulsator 40 or the inner tub 30 rotates to progress the rinsing cycle. In this instance, for improving a rinsing efficiency, the rinsing cycle can be performed a few times, between which rinsing cycles a drain cycle and a spinning cycle may be performed.

After the rinsing cycle is finished completely, a final spinning cycle is performed, in which the inner tub 30 and the pulsator 40 rotates at a high speed in a state the washing water used in the rinsing is drained to an outside of the cabinet, naturally. According to this, water is extracted from the laundry to the outer tub 20 through the pass through hole 31 of the inner tub 30 by the centrifugal force. In this instance, since the drain valve 13 under the outer tub 20 is in an opened state, the water from the laundry is drained to an outside of the cabinet through the drain hose 14.

The spinning cycle is performed for a preset time period, and when the spinning cycle is completed, operation of the washing machine is stopped fully, to finish all washing process.

However, a related art washing machine has contaminants from the laundry during washing, detergent, residue of softener, mixtures thereof remained on an inside and outside walls of the inner tub 30, and on an inside wall of the outer tub 20. A contaminated tub in turn causes contamination of the laundry during washing, to drop a reliability of the product in view of sanitary.

In the meantime, in general, as the washing machine is used for a long time, contaminants stuck to the inside and outside surfaces of the inner tub 30, and inside surface of the outer tub 20 accumulates gradually to a great amount. However, in the related art, since the user determines a tub cleaning time as he likes, introduces a tub cleaner, and performs the tub cleaning, even if a time when the tub cleaning is required comes actually, the tub cleaning is not performed.

Since the tub cleaning is performed according to the user's determination made as he likes in the related art, there has been a problem in that the tub cleaning is performed even in a case the tub cleaning is not required, resulting to waste the tub cleaner, water, and power.

Moreover, in the related art, not only the tub cleaning has not been performed effectively, but also it has been difficult for the user to know that tub contamination is serious to require the tub cleaning even if the tub cleaning is required actually. Therefore, since the washing is performed in a state the tub contamination is not resolved, not only a cleaning performance drops in view of sanitary, but also contamination of the laundry is caused by contamination sources, such as microbes, to drop the washing performance.

In the meantime, even if there are washing machines with the tub cleaning function for resolving the problems started from the tub contamination commercially available, the washing machines with the tub cleaning function at the present time have disadvantages in that the tub cleaning course is progressed inefficiently, to have a low tub cleaning efficiency. That is, in general, the present method for cleaning a tub of a washing machine has a low tub cleaning efficiency, not only to require an excessively long time period for the tub cleaning, but also to consume much power.

### DISCLOSURE OF INVENTION

An object of the present invention, designed to solve above problem, is to provide a method for cleaning a tub of a washing machine, for, not only enhancing a reliability of the washing machine in view of sanitary, but also cleaning the tub clean enough to prevent a washing performance from being deteriorated.

Other object of the present invention is to provide a method for cleaning a tub of a washing machine, which enables the user to know a tub cleaning period with easy, and to change the tub cleaning period as required.

The object of the present invention can be achieved by providing a method for cleaning a tub of a washing machine, including the steps of supplying water to a tub without introduction of laundry into the tub, washing for the first time for permeation of water into contaminants, and removal of contaminants lightly stuck to a surface of the tub, soaking the contaminants for a predetermined time period, washing for the second time for separating soaked contaminants from the surface of the tub, and draining water from the tub.

In other aspect of the present invention, there is provided a method for cleaning a tub of a washing machine, including the steps of supplying water to a tub without introduction of laundry into the tub, washing for the first time for permeation of water into contaminants, and removal of contaminants lightly stuck to a surface of the tub, soaking the contaminants for a predetermined time period, washing for the second time for separating soaked contaminants from the surface of the tub, draining water from the tub, and supplying water to the surface of the tub during draining for preventing the contaminants from sticking to the surface of the tub again.

In another aspect of the present invention, there is provided a method for cleaning a tub of a washing machine, including the steps of supplying water to a tub without introduction of laundry into the tub, washing for the first time for permeation of water into contaminants, and removal of contaminants lightly stuck to a surface of the tub, soaking the contaminants for a predetermined time period, washing for the second time for separating soaked contaminants from the surface of the tub, draining water from the tub for the first time, supplying water to the surface of the tub during the step of draining water from the tub for the first time for preventing the contaminants from sticking to the surface of the tub again, supplying water to the tub for the second time, rinsing the surface of the tub, and draining water from the tub for the second time.

In further aspect of the present invention, there is provided a method for cleaning a tub of a washing machine, including the steps of supplying water to a tub without introduction of laundry into the tub, washing for the first time for permeation of water into contaminants, and removal of contaminants lightly stuck to a surface of the tub, soaking the contaminants for a predetermined time period, washing for the second time for separating soaked contaminants from the surface of the tub, draining water from the tub for the first time, supplying water to the surface of the tub during the step of draining water from the tub for the first time for preventing the contaminants from sticking to the surface of the tub again, supplying water to the tub for the second time, rinsing the surface of the tub, draining water from the tub for the second time, and supplying water to the surface of the tub during the step of draining water from the tub for the second time for preventing the contaminants from sticking to the surface of the tub again.

In still further aspect of the present invention, there is provided a method for cleaning a tub of a washing machine, including the steps of supplying water to a tub without introduction of laundry into the tub, washing for the first time for permeation of water into contaminants, and removal of contaminants lightly stuck to a surface of the tub, soaking the contaminants for a predetermined time period, washing for the second time for separating soaked contaminants from the surface of the tub, draining water from the tub for the first time, supplying water to the surface of the tub during the step of draining water from the tub for the first time for preventing the contaminants from sticking to the surface of the tub again, supplying water to the tub for the second time, rinsing the surface of the tub, draining water from the tub for the second time, supplying water to the surface of the tub during the step of draining water from the tub for the second time for preventing the contaminants from sticking to the surface of the tub again, and rotating the tub at a high speed for removing water from the surface of the tub.

In the meantime, each of the methods further includes the step of rotating the tub during water is supplied to the tub.

The steps of washing are performed by rotating a pulsator provided in the tub for forming a water circulation, by rotating the tub for forming a water circulation, or by rotating the tub at a high speed for forming a water circulation moving in a radial direction of the tub. Of course, the step of washing are performed in combination of at least two methods selected from a method for rotating the pulsator, a method for rotating the tub at a low speed, and a method for rotating the tub at a high speed.

The steps of supplying water to the surface of the tub are preferably performed in a later half of the step for draining. The steps of supplying water to the surface of the tub are performed by a method in which the tub is rotated while water is supplied to the tub, or by a method in which water is sprayed to the surface of the tub.

Each of the methods further includes the step of introducing bleaching agent into the tub before washing for the first time. The bleaching agent is preferably an oxygen group bleaching agent, or a halide group bleaching agent.

Each of the methods further includes the step of introducing one or more than one sterilizing agent, and fungicidal agent. The sterilizing agent is halogenated hydantoin compound that emits hypohalogenated acid.

Each of the methods further includes the step of displaying that a tub cleaning course is under progress on a display of the washing machine during performance of the steps of tub cleaning.

Each of the methods further includes the step of displaying an accumulated number of washing times after the steps of tub cleaning are finished on a display of the washing machine.

Each of the methods further includes the step of displaying an accumulated number of washing times after the steps of tub cleaning are finished, and target number of washing times on a display of the washing machine. The target number can be changed as a user likes.

The steps of tub cleaning are performed when the user selects the tub cleaning course manually at a time the accumulated number of washing times reaches to the target number of washing times, or the steps of tub cleaning is performed automatically at a time the accumulated number of washing times reaches to the target number of washing times.

Each of the methods further includes the step of setting one of modes selected from a mode in which the user manually selects a tub cleaning course to progress the steps of tub cleaning at a time the accumulated number of washing times displayed on the display of the washing machine reaches to the target number of washing times required for the tub cleaning, and a mode in which the steps of tub cleaning are progressed automatically.

Each of the methods further includes the step of the user setting a reserved time so that the steps of tub cleaning is performed automatically if the set reserved time is reached.

### BRIEF DESCRIPTION OF DRAWINGS

The accompanying drawings, which are included to provide a further understanding of the invention, illustrate embodiments of the invention and together with the description serve to explain the principle of the invention.

In the drawings;

FIG. 1 illustrates a section of a related art pulsator type washing machine;

FIG. 2 illustrates a flow chart showing the steps of a method for cleaning a tub in accordance with a preferred embodiment of the present invention,

FIG. 3 illustrates a diagram showing an operation process of a washing machine according to the method for cleaning a tub in FIG. 2 in succession,

FIG. 4 illustrates a graph for comparing tub cleaning time periods of the tub cleaning method of the present invention and the related art tub cleaning method; and

FIG. 5 illustrates a graph for comparing power consumptions of the tub cleaning method of the present invention and the related art tub cleaning method.

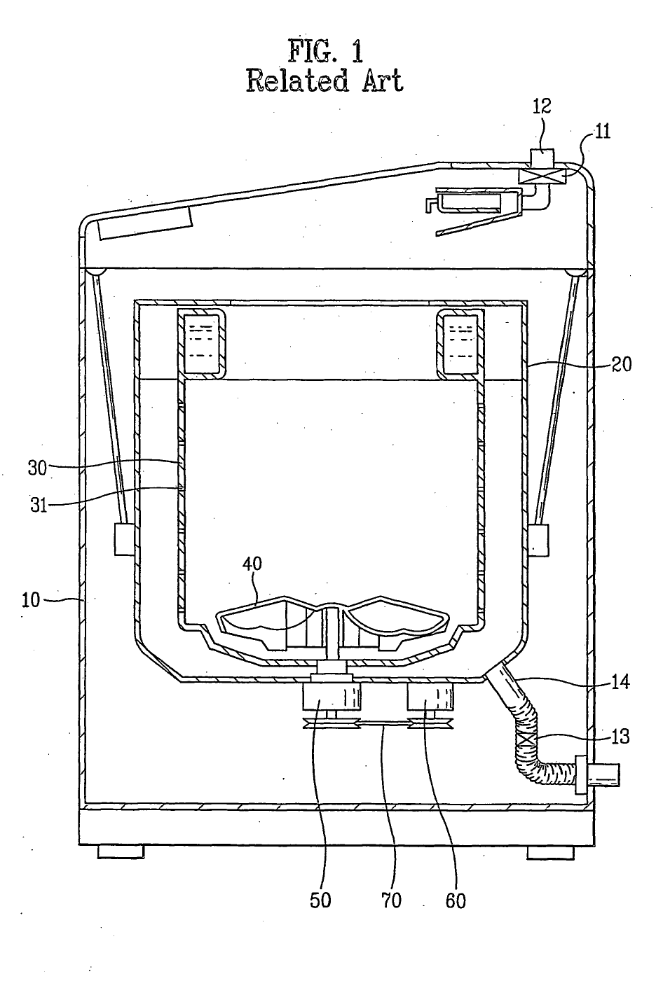

### BEST MODE FOR CARRYING OUT THE INVENTION

Reference will now be made in detail to the preferred embodiments of the present invention, examples of which are illustrated in the accompanying drawings. In describing embodiments of the present invention, identical parts will be given the same names, and additional and repetitive description of which will be omitted.

For reference, the method for cleaning a tub of the present invention is applicable not only to general pulsator type washing machines, but also to drum type washing machines. The drum type washing machine is different from the pulsator type washing machine in that the drum type washing machine has an inner tub and an outer tub arranged parallel to ground.

However, the drum type washing machine is identical to the pulsator type washing machine in that the inner tub rotates in washing, rinsing, and spinning, and the outer tub that holds water does not rotate. Since the drum type washing machines are used widely, no more description will be provided. In describing the method for cleaning a tub, the description will be made taking the pulsator type washing machine as an example.

A method for cleaning a tub in accordance with a first preferred embodiment of the present invention will be described. The method includes the steps of supplying water to a tub, washing a surface of the tub for the first time, soaking contaminants, washing the surface of the tub for the second time, and draining water from the tub.

The step of supplying water to a tub is progressed in a state no laundry is introduced into the inner tub. Once water is supplied to the inner tub, the water is also introduced into the outer tub through the pass through holes in a wall of the inner tub. According to this, the water supplied to the tub wets a surface of the tub, i.e., an inside surface and an outside surface of the inner tub, and contaminants attached to an inside surface of the tub. In the meantime, it is preferable that the inner tub is rotated when water is supplied to the tub. Then, the water can permeate the contaminants more quickly, enabling easy removal of the contaminants lightly stuck to the surface of the tub.

If the water is supplied to a preset level in the tub, the washing machine performs washing a surface of the tub for the first time for active water permeation into the contaminants. In this instance, water circulation is formed in the tub, which removes contaminants lightly stuck to the surface of the tub, or accelerates permeation of the water into the contaminants.

For forming the water circulation in the tub, the present invention may employ different methods.

As one of the methods, the pulsator in the inner tub may be rotated. That is, the pulsator causes the water circulation in the tub while the tub rotates in a regular or reverse direction.

As another method, the inner tub may be rotated. In this instance, the inner tub causes the water circulation in the tub as the inner tub rotates in a regular or reverse direction.

As still another method, the inner tub may be rotated at a fast speed. The fast rotation of the inner tub moves the water in the inner tub toward the inside wall of the outer tub at a high speed by a centrifugal force. According to this, a water circulation moving toward a radial direction of the tubs, i.e., the inner tub and the outer tub, is formed.

In the meantime, though the step of the washing a surface of the tub for the first time may be performed by one of methods selected from the method for rotating the pulsator only, the method for rotating the tub, particularly, the inner tub at a low speed, and the method for rotating the tubs, particularly, the inner tub at a high speed, the step of washing a surface of the tub for the first time may also be performed by a method in which at least two of above methods are combined.

The step of soaking contaminants is performed by a method in which the tub is left for a preset time period in a state the water is held in the tub. Once the step of soaking contaminants is passed, since the water permeates the contaminants adequately, the contaminants can be removed from a surface of the tub, easily.

The step of washing the surface of the tub for the second time is performed for separating the soaked contaminants from the surface of the tub. Since the step of washing the surface of the tub for the second time can be performed by a method the same with the step of washing a surface of the tub for the first time, a detailed description of which will be omitted. However, time periods required for washing a surface of the tub for the first time, and the second times, and methods for forming the water circulation, and the combinations may differ. Once the step of washing the surface of the tub for the second time is performed, most of the contaminants are removed from the surface of the tub.

If the step of draining water from the tub is performed, the water having the contaminants removed from the surface of, and contained in, the tub is discharged to an outside of the washing machine.

Upon finishing the method for cleaning a tub in accordance with the first preferred embodiment of the present invention, including above steps, most of the contaminants can be removed from the surface of the tub. Therefore, if laundry is washed after the tub is cleaned, contamination of the laundry by the contaminants stuck to the tub can be prevented. According to this, not only a sanitary state of the washing machine is improved, but also a washing performance is improved.

In the meantime, in the method for cleaning a tub in accordance with a first preferred embodiment of the present invention, during the drain process is progressed, a portion of the contaminants in the draining water may stuck to the surface of the tub, again. Therefore, the present invention provides a method in accordance with a second preferred embodiment of the present invention, for removing the contaminants, completely.

The method for cleaning a tub in accordance with a second preferred embodiment of the present invention includes the steps of supplying water to a tub, washing a surface of the tub for the first time, soaking contaminants, washing the surface of the tub for the second time, and draining water from the tub, and supplying water to a surface of the tub during draining. Up to the step of draining water from the tub is similar to the method of the first embodiment. Therefore, only the step of supplying water to a surface of the tub during draining will be described.

The step of supplying water to a surface of the tub is performed for preventing the contaminants in the draining water from sticking to the surface of the tub, again. That is, by supplying water to the surface of the tub at the time water is draining from the tub to an outside of the washing water, re-sticking of the contaminants to the surface of the tub is prevented. There are two methods for supplying water to the surface of the tub.

One of the methods is rotating the tub while water is supplied to the inner tub during draining. Then, water in the tub washes the surface of the tub, to prevent the contaminants from sticking to the surface of the tub, again. The method is favorably applicable to the pulsator type washing machine.

The other one of the methods is spraying water to the surface of the tub during draining. Then, clean water washes the surface of the tub, to prevent the contaminants from sticking to the surface of the tub, again.

In the meantime, it is preferable that the step of supplying water to the surface of the tub is started from a later half of the draining step. Then, waste of water can be reduced.

Thus, the second preferred embodiment of the present invention can prevent re-contamination of the tub that can take place when water is drained after washing of the tub, effectively.

In the meantime, in order to provide a tub cleaning capability much higher than the first or second tub cleaning method, the present invention provides third, and fourth embodiments additionally, which will be described hereafter.

The method for cleaning a tub in accordance with a third preferred embodiment of the present invention includes the steps of supplying water to the tub for the first time, washing a surface of the tub for the first time, soaking contaminants, washing the surface of the tub for the second time, draining water from the tub for the first time, supplying water to the tub for the second time, rinsing the surface of the tub, and draining water from the tub for the second time.

A process up to the step of supplying water to the surface of the tub is similar to the second embodiment. Therefore, a process thereafter will be described.

If the draining is finished completely, water is supplied to the tub for the second time in a state the drain valve is closed. This process, progressed by a method similar to the step of supplying water for the first time, will be omitted.

The step of rinsing the surface of the tub is performed in a state the water is supplied to the tub for the second time. In this instance, at least one of the pulsator and the inner tub is rotated, to cause water circulation for cleaning the surface of the tub. The rinsing removes contaminants, not removed yet, or stuck to the surface of the tub again, completely.

One the step of rinsing is finished, water is drained from the tub to an outside of the washing machine.

The third embodiment can make the tub cleaner.

In the meantime, the fourth embodiment further includes the step of supplying water to the surface of the tub when the step of draining is progressed in addition to the step of the third embodiments. This is similar to the step of supplying water to the surface of the tub in the second embodiment.

After laundry is introduced into the inner tub right after the tub is cleaned by above method, washing may be performed. However, after laundry is introduced into the inner tub after a long time period is passed from the cleaning the tub, washing may be performed. In this case dust in air can stuck to the surface of the tub. However, since the tub is still watery, the dust can stuck to the surface of the tub fully as the tub dries.

Therefore, the present invention further provides a method for cleaning a tub in accordance with a fifth preferred embodiment of the present invention that can solve above problem. The fifth embodiment method for cleaning the tub includes the steps of supplying water to a tub for the first time, washing a surface of the tub for the first time, soaking contaminants, washing the surface of the tub for the second time, draining water from the tub for the first time, supplying water to the surface of the tub during draining, supplying water to the tub for the second time, rinsing the surface of the tub, draining water from the tub for the second time, supplying water to the surface of the tub during the second time draining, and spinning the tub. Since a process up to the step of supplying water to the surface of the tub during the second time draining is similar to the fourth embodiment, description of the process will be omitted.

The step of spinning the tub is progressed by a method in which the tub, more specifically the inner tub is rotated at a high speed. Then, water is removed from the surface of the tub by a centrifugal force, to dry the surface of the tub. Once the surface of the tub is dried, the strong sticking of the dust to the surface of the tub can be prevented. According to this, a tub cleaning capability, and a level of sanitary can be improved. Of course, washing performance preformed thereafter can be improved.

The step of spinning the tub may be performed after a process for cleaning the tub in accordance with one of the first to third embodiments is finished.

Time periods required for performing respective steps in each of the embodiments differ with washing capacities of the washing machines, kinds and amounts of detergents used in regular washing, and the like.

In the meantime, the method for cleaning a tub of the present invention may further include the step of introducing a bleaching agent into the tub before the step of washing the surface of the tub for the first time in the tub cleaning process of each of the embodiments. That is, if the tub is contaminated heavily, the tub is cleaned with the bleaching agent.

As the bleaching agent, an oxygen group bleaching agent, or a chloride group bleaching agent may be used. Though the use of the oxygen group bleaching agent has no problem, the chloride group bleaching agent may corrodes the inner tub. Therefore, it is required to pay attention so that there is no occasion when a tub cleaning course is progressed, not normally, but left for a long time unattended, in a state the chloride group bleaching agent is introduced.

Moreover, the method for cleaning a tub of the present invention may further include the step of introducing a sterilizing agent or fungicidal agent into water in the tub. As the sterilizing agent, halogenated hydantoin compound that emits hypohalogenated acid may be used, mostly. The step of introducing a sterilizing agent or fungicidal agent into water in the tub may be performed at the same time with, or right after the step of supplying water for the first time, or at the same time with, or right after the step of supplying water for the second time.

In the meantime, the present invention, not only provides a method for cleaning a tub, but also suggests a method for enabling the user to know a proper time for cleaning the tub, easily. The method is applicable to all of the first to fifth methods, which will be described hereafter in detail.

The method for cleaning a tub of the present invention may further include the step of displaying a tub cleaning course under progress on a display of the washing machine when one of the tub cleaning processes in accordance with the embodiments of the present invention is progressed. In this case, the user can notice if washing, or the tub cleaning, is in progress presently, from an outside of the washing machine, easily.

The method for cleaning a tub of the present invention further includes the step of displaying an accumulated number of washing times after above steps are performed for tub cleaning, so that the user can notice a proper tub washing time, easily.

In the meantime, if the accumulated number of washing times is displayed on a display, it is preferable that a target number of washing times required for the tub cleaning is displayed additionally together with the accumulated number of washing times. Then, the user can determine a proper time required for the tub cleaning.

For an example, if it is displayed on the display that the present accumulated number of washing times is 20, and the target number of washing times is 30, the user can determine that it is not a proper time for the tub cleaning. Thereafter, if the accumulated number of washing times increases gradually to equal to, or greater than 30, the user determines that the tub cleaning is required, and progressed the tub cleaning course.

Thus, in a case the accumulated number of washing times reaches to the target number of washing times, of course, the reach of the accumulated number of washing times may be announced to the user by different means, such as alarm, or synthetic voice, besides it is displayed on the display in characters, or codes.

In the meantime, the proper tub cleaning time may differ with kinds and amount of detergents used, capacity of the washing machine, and water quantity used. Therefore, it is preferable that the target number of washing times is adjustable at the user option by handling a control panel of the washing machine.

In the meantime, above description is for user's manual selection of the tub cleaning course, and progressing the method for cleaning a tub, when the present accumulated number of washing times displayed on the display of the washing machine reaches to, exceeds the target number of washing times required for the tub cleaning.

However, besides this method, it is possible that the tub cleaning course is progressed automatically under the control of a microcomputer of the washing machine if the accumulated number of washing times reaches to the target number of washing times.

For this, it is preferable that the user can select one of a manual cleaning mode and automatic cleaning mode by handling the control panel.

The manual cleaning mode is a mode in which the user manually selects the tub cleaning course, and progresses steps for cleaning the tub, when the accumulated number of washing times displayed on the washing machine reaches to the target number of washing times required for tub cleaning. If such a manual cleaning mode is selected, it is preferable that the tub cleaning course is progressed before the laundry is introduced into the inner tub, or the laundry is taken out of the inner tub fully after the spinning is finished.

The automatic cleaning mode is a mode in which steps for cleaning the tub are progressed automatically, when the accumulated number of washing times displayed on the washing machine reaches to the target number of washing times required for tub cleaning. If such an automatic cleaning mode is selected, it is preferable that the tub cleaning course is progressed automatically after the laundry is taken out of the inner tub, fully.

Different from above, the user may set a time for automatic performance of the steps of tub cleaning when the set time is reached. In this case, it is preferable that the control pattern is provided with a tub cleaning course reservation button, and a reservation time input button.

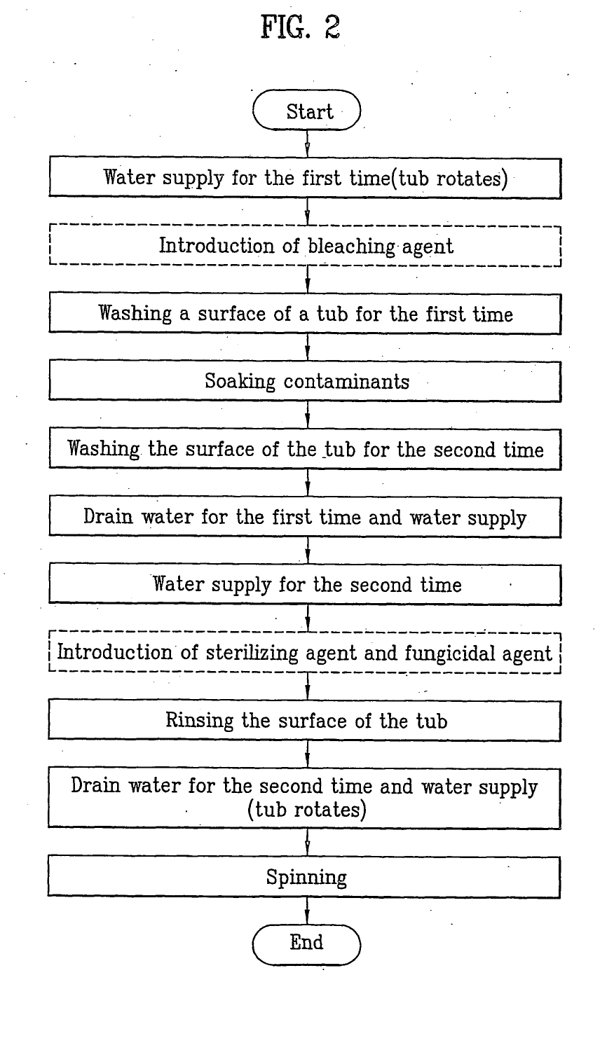

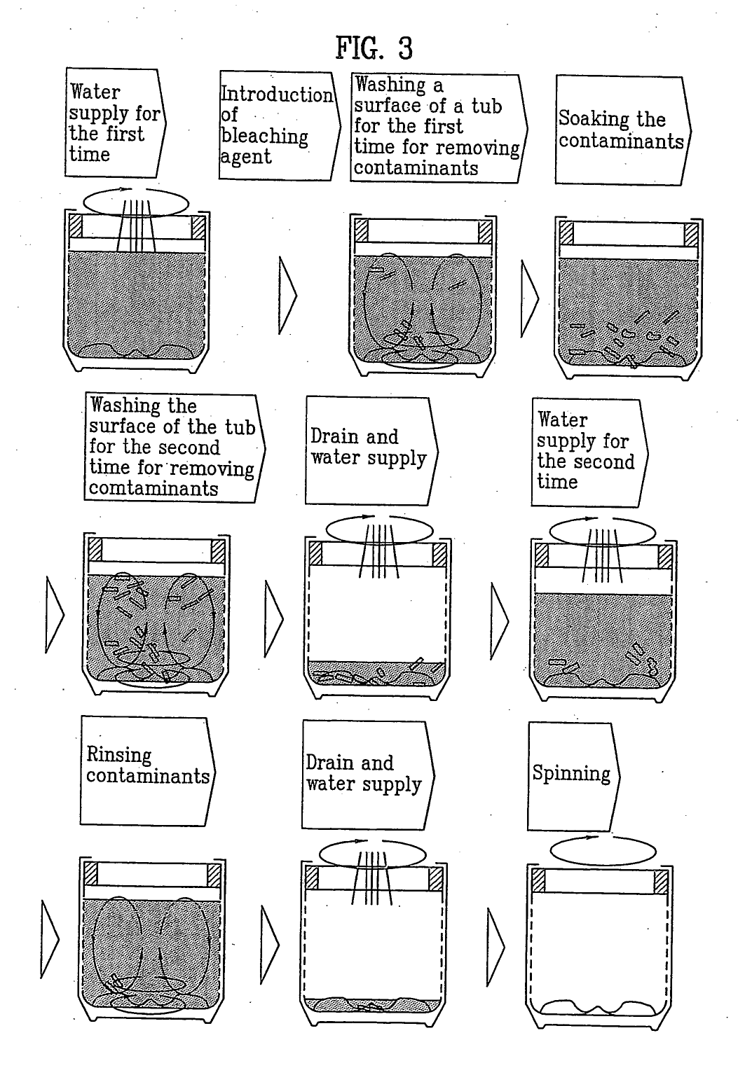

A tub cleaning process of the present invention having above methods will be described with reference to FIGS. 2 and 3. For reference, FIG. 2 or 3 illustrates a process for cleaning a tub in accordance with a fifth preferred embodiment of the present invention.

At first, the user handles the control panel, to set the manual cleaning mode, or the automatic cleaning mode. Of course, the tub cleaning reservation time may be set.

If the user selects the manual cleaning mode, the user compares the accumulated number of washing times and the target number of washing times on the display, and selects the tub cleaning course when the accumulated number of washing times reaches to the target number of washing times. On the other hand, if the automatic cleaning course is selected, the tub cleaning course is progressed automatically when the accumulated number of washing times reaches to the target number of washing times. In the meantime, if the reservation time is set, the tub cleaning course is progressed automatically when the set reservation time is reached.

Referring to FIGS. 2 and 3, if the tub cleaning course is progressed, water is supplied in a state no laundry is introduced. In this instance, the tub, more specifically, the inner tub is rotated. If water is supplied to the tub, the contaminants stuck to the surface of the tub are wet.

When water is supplied to the tub thus, bleaching agent is introduced if necessary. Of course, sterilizing agent, or fungicidal agent may be introduced.

After the water supply is finished, the pulsator or the inner tub is rotated for washing the surface of the tub for the first time. In this instance, foreign matters lightly stuck to the surface of the tub is removed from the surface of the tub, and the water actively permeates the foreign matters stuck to the surface of the tub, strongly.

After the step of washing the surface of the tub for the first time is finished, the washing machine is left as it is for a predetermined time period in a state the pulsator or the inner tub is stationary, to soak the contaminants. The water permeates the contaminants stuck to the surface of the tub in the soaking step adequately, such that the contaminants can be separated from the surface of the tub, easily.

After the soaking is finished, a water circulation is caused in the tub, to perform the step of washing the surface of the tub for the second time. Then, most of the contaminants are separated from the surface of the tub. After the step of washing the surface of the tub for the second time is finished, water is drained from the tub. In this instance, in order to prevent the contaminants from sticking to the inside wall of the tub again, it is preferable that water is supplied to an inside wall of the tub.

After the draining is finished, water is supplied to the tub again. In this instance, the tub may rotated, and the sterilizing agent, and the fungicidal agent may be introduced.

Then, water circulation is caused in the tub, to rinse the surface of the tub. Then, almost all contaminants remained on the surface of the is separated.

After the rinsing is finished, water is drained from the tub, and, for preventing the inside wall of the tub, water is supplied to the inside wall of the tub in a later half of the draining. As shown in FIG. 3, in a case of the pulsator type washing machine, water is supplied to the tub while the inner tub is rotated.

Upon finishing above process, the inner tub is rotated at a high speed, to remove water from the tub.

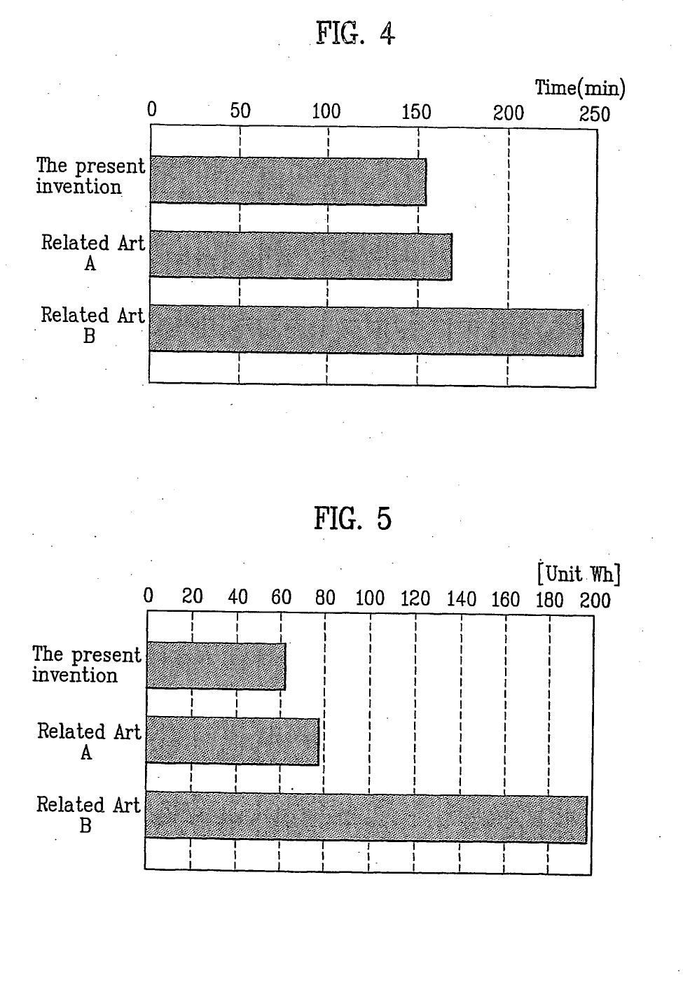

FIGS. 4 and 5 illustrate graphs for comparing tub cleaning time periods, and power consumptions of the tub cleaning method of the present invention and the related art tub cleaning method, respectively. It can be noted from FIGS. 4 and 5 that a case the tub cleaning is performed according to the tub cleaning method the present invention suggests can reduce a time period, and power consumption required for the tub cleaning compared to a case the tub cleaning is performed according to the related art tub cleaning method even if the same tub cleaning effects are provided.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

### INDUSTRIAL APPLICABILITY

As has been described, the present invention provides an optimal tub cleaning method, and removes a contamination source stuck to the tub, effectively. Therefore, the present invention prevents laundry from being contaminated by contamination of the tub, and smelling by microbes, such as fungi in the contaminants. Therefore, the present invention can improve reliability of the washing machine, not only in view of sanitary, but also performance of the washing. Moreover, the present invention enables the user to know the tub cleaning accurately. Therefore, the user can perform the tub cleaning at an accurate time required for the tub cleaning. According to this, waste of power and water can be reduced.

1. A method for cleaning a tub of a washing machine, comprising the steps of:
supplying water to a tub without introduction of laundry into the tub;
permeating water into contaminants;
removing contaminants stuck to a surface of the tub;
soaking the contaminants for a predetermined time period;
separating soaked contaminants from the surface of the tub; and
draining water from the tub.

2. A method for cleaning a tub of a washing machine, comprising the steps of:
supplying water to a tub without introduction of laundry into the tub;
permeating water into contaminants;
removing contaminants stuck to a surface of the tub;
soaking the contaminants for a predetermined time period;
separating soaked contaminants from the surface of the tub;
draining water from the tub; and
supplying water to the surface of the tub during draining thereby preventing re-sticking of the contaminants to the surface of the tub.

3. A method for cleaning a tub of a washing machine, comprising the steps of:
supplying water to a tub without introduction of laundry into the tub;
permeating water into contaminants;
removing contaminants stuck to a surface of the tub:
soaking the contaminants for a predetermined time period;
separating soaked contaminants from the surface of the tub;
draining water from the tub a first time;
supplying water to the surface of the tub during the step of draining water from the tub for a first time thereby preventing re-sticking of the contaminants to the surface of the tub;
supplying water to the tub a the second time;
rinsing the surface of the tub; and
draining water from the tub for a second time.

4. A method for cleaning a tub of a washing machine, comprising the steps of:
supplying water to a tub without introduction of laundry into the tub;
permeating water into contaminants; and
removing contaminants stuck to a surface of the tub;
soaking the contaminants for a predetermined time period;
separating soaked contaminants from the surface of the tub;
draining water from the tub a first time;
supplying water to the surface of the tub during the step of draining water from the tub for the first time thereby preventing re-sticking of the contaminants to the surface of the tub;
supplying water to the tub for a second time;
rinsing the surface of the tub;
draining water from the tub for a second time; and
supplying water to the surface of the tub during the step of draining water from the tub for the second time thereby preventing re-sticking of the contaminants to the surface of the tub.

5. A method for cleaning a tub of a washing machine, comprising the steps of:
supplying water to a tub without introduction of laundry into the tub;
permeating water into contaminants;
removing contaminants stuck to a surface of the tub;
soaking the contaminants for a predetermined time period;
separating soaked contaminants from the surface of the tub;
draining water from the tub for a first time;
supplying water to the surface of the tub during the step of draining water from the tub for the first time thereby preventing re-sticking of the contaminants to the surface of the tub;
supplying water to the tub for a second time;
rinsing the surface of the tub;
draining water from the tub for a second time;
supplying water to the surface of the tub during the step of draining water from the tub for the second time thereby preventing re-sticking of the contaminants to the surface of the tub; and
rotating the tub at a high speed thereby removing water from the surface of the tub.

6. The method as claimed in claim 1, further comprising the step of rotating the tub while water is supplied to the tub.

7. The method as claimed in claim 1, wherein the step of washing is performed by rotating a pulsator provided in the tub for forming a water circulation.

8. The method as claimed in claim 1, wherein the step of permeating water further includes rotating the tub for forming a water circulation.

9. The method as claimed in claim 1, wherein the step of permeating water further includes rotating the tub at a high speed thereby circulating water in a radial direction of the tub.

10. The method as claimed in claim 1, wherein the step of permeating water further includes rotating a pulsator and rotating the tub at a low speed.

11. The method as claimed in claim 2, wherein the step of supplying water to the surface of the tub is performed during a later half of the draining step.

12. The method as claimed in claim 2, wherein the step of supplying water to the surface of the tub further includes rotating the tub while water is supplied to the tub.

13. The method as claimed in claim 2, wherein the step of supplying water to the surface of the tub further includes spraying water to the surface of the tub.

14. The method as claimed in claim 1, further comprising the step of rotating the tub at a high speed thereby removing water from the surface of the tub.

15. The method as claimed in claim 1, further comprising the step of introducing a bleaching agent into the tub before permeating water into contaminants.

16. The method as claimed in claim 15, wherein the bleaching agent is an oxygen group bleaching agent.

17. The method as claimed in claim 15, wherein the bleaching agent is a halide group bleaching agent.

18. The method as claimed in claim 1, further comprising the step of introducing at least one sterilizing agent and a fungicidal agent.

19. The method as claimed in claim 18, wherein the sterilizing agent is halogenated hydantoin compound that emits hypohalogenated acid.

20. The method as claimed in claim 1, further comprising the step of displaying a tub cleaning course which is under progress on a display of the washing machine during tub cleaning.

21. The method as claimed in claim 1, further comprising the step of displaying an accumulated number of washing times after tub cleaning on a display of the washing machine.

22. The method as claimed in claim 1, further comprising the step of displaying an accumulated number of washing times after of tub cleaning, and a target number of washing times on a display of the washing machine.

23. The method as claimed in claim 22, wherein the target number can be changed.

24. The method as claimed in claim 22, wherein the steps of tub cleaning are performed when a user manually selects a tub cleaning course when the accumulated number of washing times reaches the target number of washing times.

25. The method as claimed in claim 22, wherein the steps of tub cleaning are performed automatically when the accumulated number of washing times reaches the target number of washing times.

26. The method as claimed in claim 1, further comprising the step of setting a mode where a user manually selects a tub cleaning course when the accumulated number of washing times displayed on the display of the washing machine reaches a target number of washing times required for the tub cleaning.

27. The method as claimed in claim 1, further comprising the step of setting a reserved time so that tub cleaning is performed automatically if the set reserved time is reached.

28. The method as claimed in claim 1, further comprising the step of setting a mode where tub cleaning automatically progresses.

29. The method as claimed in claim 1, wherein the step of separating contaminants further includes rotating the tub for forming a water circulation.

30. The method as claimed in claim 1, wherein the step of separating contaminants further includes rotating the tub at a high speed thereby circulating water in a radial direction of the tub.

31. The method as claimed in claim 1, wherein the step of permeating water further rotating a pulsator and rotating the tub at a high speed.

32. The method as claimed in claim 1, wherein the step of permeating water further includes rotating the tub at a low speed and rotating the tub at a high speed.

33. The method as claimed in claim 1, wherein the step of separating contaminants further includes rotating a pulsator and rotating the tub at a low speed.

34. The method as claimed in claim 1, wherein the step of separating contaminants further includes rotating a pulsator and rotating the tub at a high speed.

35. The method as claimed in claim 1, wherein the step of separating contaminants further includes rotating the tub at a low speed and rotating the tub at a high speed.
